(19) United States
(12) Patent Application Publication
(10) Pub. No.: US 2026/0349085 A1
(43) Pub. Date: Nov. 5, 2026

(54) LIDAR AND VEHICLE

(71) Applicant: AUTOX TECH PTE. LTD., SINGAPORE (SG)

(72) Inventors: Zhenkun Wang, Shenzhen (CN); Yanan Zhi, Shenzhen (CN); Xin Wang, Shenzhen (CN); Jianxiong Xiao, Shenzhen (CN); Yizhou Shan, Shenzhen (CN); Xuhui Tao, Shenzhen (CN)

(73) Assignee: AUTOX TECH PTE. LTD., SINGAPORE (SG)

(21) Appl. No.: 19/194,048

(22) Filed: Apr. 30, 2025

(51) Int. Cl. G01S 7/481; G01S 7/4865; G01S 17/32; G01S 17/88

(52) U.S. Cl. CPC G01S 7/4817; G01S 7/4811; G01S 7/4865; G01S 17/32; G01S 17/88

(57) ABSTRACT

The disclosure provides a LiDAR, including a TOF transceiver assembly, an FMCW transceiver assembly, a wavelength-selective beam splitter, and an optical de-rotation assembly. The beam splitter directs a TOF beam and an FMCW beam co-axially into the de-rotation assembly, with one beam reflected and the other transmitted. The rotating de-rotation assembly scans both beams onto a target, which generates return beams that propagate back through the assembly. The beam splitter then separates the return beams to their respective transceiver assemblies for detection.

### TECHNICAL FIELD

The disclosure relates to the technical field of LiDARs, and in particular, to a LiDAR and a vehicle.

### BACKGROUND

The essence of laser three-dimensional imaging is parallel laser ranging, which indirectly or directly acquires the time difference between a laser emission signal and an echo signal to obtain a distance image of a target. A scanning three-dimensional imaging LiDAR, which is composed of a single-point laser coherent or non-coherent ranging system equipped with a beam scanning device, is a currently relatively mature three-dimensional imaging LiDAR technology.

Current vehicle-mounted LiDARs can be classified into time-of-flight (TOF) LiDARs and frequency-modulated continuous wave (FMCW) LiDARs according to detection principles. The TOF method directly obtains the time difference by measuring the difference between the signal emission time and the echo response time of a detector, and then calculates the distance information of the target by combining the propagation speed of electromagnetic waves in the air. The FMCW method emits a continuous wave with varying frequency within a sweep period, and there is a frequency difference between the echo reflected by an object and the emission signal. By measuring the frequency difference, the distance information between the target and the radar can be obtained, and the velocity information can be calculated based on the Doppler effect. Although the TOF method has the advantages of simple measurement, small size, and high angular resolution, and the FMCW method has the advantages of being capable of both ranging and velocity measurement and achieving high-resolution detection with low emission power, the TOF method is not accurate and real-time in velocity measurement, and the FMCW method has complex calculation and low angular resolution.

### SUMMARY

In view of the above, it is necessary to provide a LiDAR and a vehicle that can integrate the TOF method and the FMCW method to achieve omnidirectional scanning imaging without image rotation.

In a first aspect, the disclosure provides a LiDAR. The LiDAR includes a TOF transceiver assembly, an FMCW transceiver assembly, a wavelength-selective beam splitter, and an optical de-rotation assembly. Wherein:

The wavelength-selective beam splitter is optically coupled to the optical de-rotation assembly.

A first optical beam emitted by the TOF transceiver assembly and a second optical beam emitted by the FMCW transceiver assembly are incident on the optical de-rotation assembly, wherein: one of the first optical beam or the second optical beam is reflected by the wavelength-selective beam splitter toward the optical de-rotation assembly, and the other of the first optical beam or the second optical beam passes through the wavelength-selective beam splitter and is incident on the optical de-rotation assembly.

The optical de-rotation assembly is configured to rotate around a first axis, and the first optical beam and the second optical beam are emitted from the LiDAR through the optical de-rotation assembly.

The first optical beam and the second optical beam are reflected by an object to generate a first return beam and a second return beam, respectively.

The first return beam is received by the TOF transceiver assembly after sequentially propagating the optical de-rotation assembly and the wavelength-selective beam splitter.

The second return beam is received by the FMCW transceiver assembly after sequentially propagating the optical de-rotation assembly and the wavelength-selective beam splitter.

In a second aspect, the disclosure provides a vehicle. The vehicle includes a vehicle body and the LiDAR as described above, wherein the LiDAR is disposed on the vehicle body.

In the above LiDAR and vehicle, by disposing a wavelength-selective beam splitter in the LiDAR, the first optical beam emitted by the TOF transceiver assembly and the second optical beam emitted by the FMCW transceiver assembly are combined, and the first return beam formed by the first optical beam and the second return beam formed by the second optical beam are split, thereby realizing the integrated use of the TOF transceiver assembly and the FMCW transceiver assembly. By integrating the TOF transceiver assembly and the FMCW transceiver assembly in the same LiDAR and rotating the optical de-rotation assembly, omnidirectional scanning without image rotation is achieved. Without increasing or with minimal increase in the volume of the LiDAR, the reuse of two radar technologies, namely the TOF method and the FMCW method, is realized, so that the LiDAR can simultaneously perform distance and velocity measurements and acquire high-density point cloud data about objects. This enables the LiDAR to eliminate the structure of traditional multi-line LiDAR upper and lower warehouses, reduce the number of components, and has the advantages of no fast-axis scanning, small moment of inertia, simple structure, high reliability, easy assembly, and integrable miniaturization, thus having good development prospects in the field of vehicle-mounted LiDARs.

### BRIEF DESCRIPTION OF THE DRAWINGS

To more clearly illustrate the technical solutions in the embodiments of the disclosure or in the prior art, the drawings to be used in the description of the embodiments or the prior art will be briefly introduced below. It is apparent that the drawings described below are merely some embodiments of the disclosure, and for those skilled in the art, other drawings can be obtained based on the structures shown in these drawings without creative efforts.

FIG. 1 is a schematic diagram of the internal structure of a LiDAR provided by an embodiment of the disclosure.

FIG. 2 is a system schematic diagram of a LiDAR provided by an embodiment of the disclosure.

FIG. 3 is a front view of a LiDAR in accordance with an embodiment.

FIG. 4 is a first front view of a LiDAR in accordance with an embodiment.

FIG. 5 is a left view of a LiDAR in accordance with an embodiment.

FIG. 6 is a bottom view of a LiDAR in accordance with an embodiment.

FIG. 7 is a second front view of a LiDAR in accordance with an embodiment.

FIG. 8 is a schematic diagram of a vehicle provided by an embodiment of the disclosure.

The realization of the objectives, functional features, and advantages of the disclosure will be further described below with reference to the embodiments and the drawings.

### DETAILED DESCRIPTION OF THE EMBODIMENTS

In order to make the purpose, technical solution, and advantages of this application clearer and clearer, the following will provide further detailed explanations of this application in conjunction with the accompanying drawings and embodiments. It should be understood that the specific embodiments described here are only intended to explain the present application and are not intended to limit the present application. Based on the embodiments in this application, all other embodiments obtained by ordinary technical personnel in this field without creative labor fall within the scope of protection of this application.

The terms “first,” “second,” “third,” “fourth,” etc. (if present) in the specification, claims, and accompanying drawings of the present application are used to distinguish similar planning objects and are not necessarily used to describe a specific sequence or order. It should be understood that such terms, when used, may be interchangeable under appropriate circumstances. In other words, the described embodiments may be implemented in an order other than that illustrated or described herein. Furthermore, the terms “include” and “have” and any variations thereof may also encompass additional content. For example, a process, method, system, product, or device comprising a series of steps or units is not limited to only those steps or units clearly listed but may include other steps or units not clearly listed or inherent to those processes, methods, products, or device.

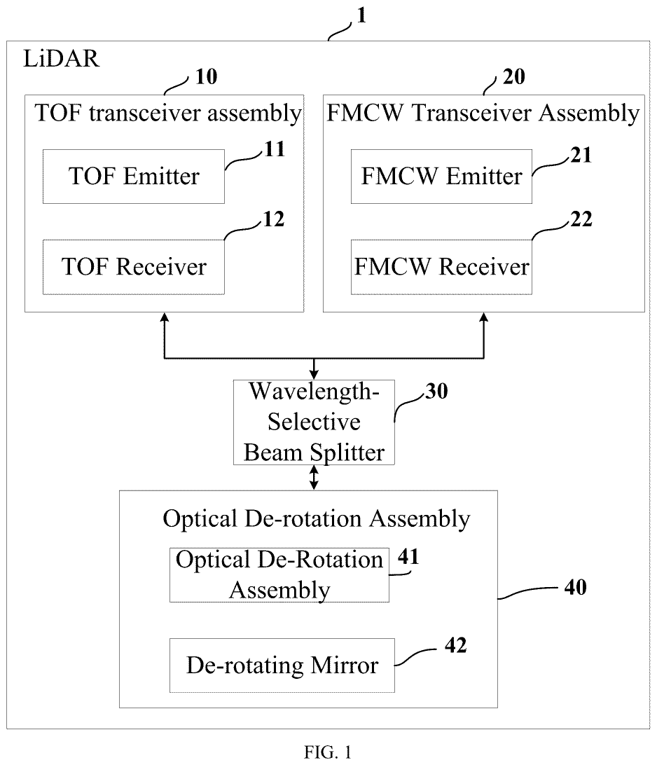

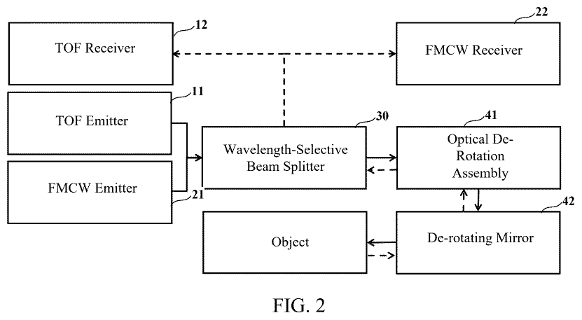

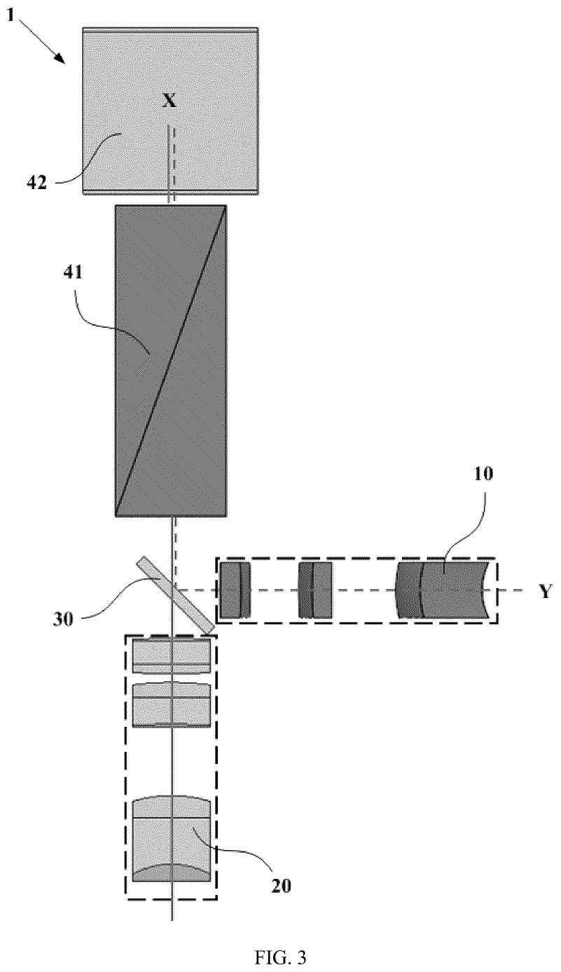

Referring to FIGS. 1, 2, and 3. FIG. 1 is a schematic diagram of the internal structure of a LiDAR provided by an embodiment of the disclosure. FIG. 2 is a system schematic diagram of a LiDAR provided by an embodiment of the disclosure. FIG. 3 is a front view of a LiDAR in accordance with an embodiment. The LiDAR 1 comprises a TOF transceiver assembly 10, an FMCW transceiver assembly 20, a wavelength-selective beam splitter 30, and an optical de-rotation assembly 40.

The TOF transceiver assembly 10 emits a first optical beam, and the FMCW transceiver assembly 20 emits a second optical beam. The first optical beam and the second optical beam are reflected by an object to generate a first return beam and a second return beam, respectively. It can be understood that wavelengths of the first optical beam and the second optical beam are different. For example, the wavelength of the first optical beam emitted by the TOF transceiver assembly 10 is 905 nm, and the wavelength of the second optical beam emitted by the FMCW transceiver assembly 20 is 1550 nm.

In this embodiment, the TOF transceiver assembly 10 includes a TOF emit2

eam, and the TOF receiver 12 is configured to receive the first return beam. The FMCW transceiver assembly 20 includes an FMCW emitter 21, and an FMCW receiver 22. The FMCW emitter 21 is configured to emit the second optical beam, and the FMCW receiver 22 is configured to receive the second return beam.

The TOF emitter 11 and the FMCW emitter 21 can be composed of a plurality of lasers arranged in parallel, the plurality of lasers arranged at a certain angle, or a single laser that can emit a plurality of beams, which is not limited here. The TOF emitter 11 can simultaneously emit a plurality of first optical beam, or can sequentially emit a plurality of first optical beams according to a predetermined timing sequence. The FMCW emitter 21 can simultaneously emit a plurality of second optical beams, or can sequentially emit a plurality of second optical beams according to a predetermined timing sequence. Furthermore, the emission of the first optical beam by the TOF emitter 11 and the emission of the second optical beam by the FMCW emitter 21 are performed simultaneously.

The TOF transceiver assembly 10 and the FMCW transceiver assembly 20 can include pre-collimators or collimators. After propagating the pre-collimator or collimator, the first optical beam and the second optical beam become collimated beams. The pre-collimator or collimator is a multi-channel collimator capable of collimating the plurality of beams simultaneously.

For example, the TOF transceiver assembly 10 includes a 905 nm TOF emitter 11 (the TOF emitter with a wavelength of 905 nm) and a 905 nm collimator (the collimator with a wavelength of 905 nm). The first optical beam is emitted from the TOF emitter 11, which is composed of a laser array, and then enters the 905 nm collimator for collimation. The FMCW transceiver assembly 20 comprises a 1550 nm FMCW emitter 21 (the FMCW emitter with a wavelength of 1550 nm) and a 1550 nm collimator (a collimator with a wavelength of 1550 nm). The FMCW emitter 12 generates a beam array at 1550 nm wavelength, which is transmitted via an optical fiber to the 1550 nm collimator for collimation.

The wavelength-selective beam splitter 30 is disposed on one side of the optical de-rotation assembly 40, and the optical de-rotation assembly 40 rotates around the first axis X. One of the first optical beam and the second optical beam is incident to the optical de-rotation assembly 40 via reflection by the wavelength-selective beam splitter 30, and the other passes through the wavelength-selective beam splitter 30 and is incident to the optical de-rotation assembly 40. The wavelength-selective beam splitter 30 is a dichroic mirror.

In this embodiment, the wavelength-selective beam splitter 30 is rotated 45° counterclockwise along the first axis X, and the wavelength-selective beam splitter 30 includes a reflective surface located on a side close to the optical de-rotation assembly 40. One of the TOF transceiver assembly 10 and the FMCW transceiver assembly 20 is disposed along the first axis X, and the other is disposed along the second axis Y. The second axis Y is perpendicular to the first axis X.

The wavelength-selective beam splitter 30 has wavelength selectivity, having high transmittance for the first optical beam and high reflectivity for the second optical beam, or having high reflectivity for the first optical beam and high transmittance for the second optical beam. That is, the wavelength-selective beam splitter 30 can allow the first optical beam to pass through while reflecting the second optical beam, or can reflect the first optical beam while allowing the second optical beam to pass through. After propagating the wavelength-selective beam splitter 30, the first optical beam and the second optical beam are combined and incident to the optical de-rotation assembly 40.

When the wavelength-selective beam splitter 30 allows the first optical beam to pass through and reflects the second optical beam, the TOF transceiver assembly 10 is disposed along the first axis X, and the FMCW transceiver assembly 20 is disposed along the second axis Y. The TOF transceiver assembly 10 is located on a side of the wavelength-selective beam splitter 30 away from the optical de-rotation assembly 40, and the FMCW transceiver assembly 20 faces the reflective surface of the wavelength-selective beam splitter 30.

When the wavelength-selective beam splitter 30 reflects the first optical beam and allows the second optical beam to pass through, the TOF transceiver assembly 10 is disposed along the second axis Y, and the FMCW transceiver assembly 20 is disposed along the first axis X. The FMCW transceiver assembly 20 is located on a side of the wavelength-selective beam splitter 30 away from the optical de-rotation assembly 40, and the TOF transceiver assembly 10 faces the reflective surface of the wavelength-selective beam splitter 30.

The first optical beam and the second optical beam are emitted out of the LiDAR 1 via the optical de-rotation assembly 40, thereby realizing synchronous scanning of objects by the TOF transceiver assembly 10 and the FMCW transceiver assembly 20. The first return beam is received by the TOF transceiver assembly 10 after sequentially propagating the optical de-rotation assembly 40 and the wavelength-selective beam splitter 30. The second return beam is received by the FMCW transceiver assembly 20 after sequentially propagating the optical de-rotation assembly 40 and the wavelength-selective beam splitter 30.

It can be understood that after being combined by the wavelength-selective beam splitter 30, the first optical beam and the second optical beam have the same optical path. The first return beam and the second return beam return along the corresponding optical paths, and are received by the TOF transceiver assembly 10 and the FMCW transceiver assembly 20 respectively after being split by the wavelength-selective beam splitter 30.

The optical de-rotation assembly 40 includes a de-rotating prism 41, and a de-rotating mirror 42. The de-rotating mirror 42 is disposed on a side of the de-rotating prism 41 away from the wavelength-selective beam splitter 30. After propagating the wavelength-selective beam splitter 30, the first return beam and the second return beam are simultaneously incident to the de-rotating prism 41 along the first axis X and are emitted out of the LiDAR 1 via reflection by the de-rotating mirror 42. In this embodiment, the de-rotating mirror 42 is rotated 45° counterclockwise along the first axis X. The reflective surface of the de-rotating mirror 42 is located on a side close to the de-rotating prism 41.

In this embodiment, the de-rotating prism 41 is a prism with image inversion function, including but not limited to a Dove prism, a Pechan prism, etc. For example, the de-rotating prism 41 is a Dove prism. The Dove prism comprises a first leg surface, a base surface, and a second leg surface. The first leg surface is close to the wavelength-selective beam splitter 30, and the second leg surface is close to the de-rotating mirror 42. After being incident to the de-rotating prism 41, the first optical beam and the second optical beam are refracted to the base surface via the first leg surface, then reflected to the second leg surface via the base surface, and finally refracted to the de-rotating mirror 42 via the second leg surface. The de-rotating mirror 42 is a plane mirror. Through reflection by the de-rotating mirror 42, the first optical beam and the second optical beam can be emitted out of the LiDAR 1 substantially along the horizontal direction of the LiDAR 1, forming a vertical field of view with a certain angle in the vertical direction of the LiDAR 1 and a horizontal field of view with a certain angle in the horizontal direction of the LiDAR 1. The vertical direction of the LiDAR 1 is parallel to the first axis X, and the horizontal direction of the LiDAR 1 is parallel to the second axis Y. Specifically, the field of view angle of the vertical field of view of the LiDAR 1 is 30°. The optical de-rotation assembly 40 can rotate 360° around the first axis X, that is, both the de-rotating prism 41 and the de-rotating mirror 42 rotate 360° around the first axis X, so that the field of view angle of the horizontal field of view of the LiDAR 1 is 360°, achieving omnidirectional scanning in the horizontal direction. Therefore, the LiDAR 1 can achieve a scanning range of 30°*360°.

A first rotation speed of the de-rotating prism 41 rotating around the first axis X is different from a second rotation speed of the de-rotating mirror 42 rotating around the first axis X. Furthermore, the second rotation speed is twice the first rotation speed. The de-rotating prism 41 and the de-rotating mirror 42 cooperate with each other to achieve the image-rotation-cancellation function.

Taking the LiDAR shown in FIG. 3 as an example, the wavelength-selective beam splitter 30 reflects the first optical beam and allows the second optical beam to pass through. The FMCW transceiver assembly 20 is disposed along the first axis X on a side of the wavelength-selective beam splitter 30 away from the optical de-rotation assembly 40, and the TOF transceiver assembly 10 is disposed along the second axis Y. The first optical beam is incident to the wavelength-selective beam splitter 30 along the second axis Y, reflected by the wavelength-selective beam splitter 30, and incident to the de-rotating prism 41 along the first axis X. The second optical beam passes through the wavelength-selective beam splitter 30 along the first axis X and is incident to the de-rotating prism 41 along the first axis X. Both the first optical beam and the second optical beam are incident to the de-rotating mirror 42 along the first axis X.

Correspondingly, the first return beam and the second return beam are reflected by the de-rotating mirror 42, incident to the de-rotating prism 41 along the first axis X, and incident to the wavelength-selective beam splitter 30 along the first axis X. The first return beam is reflected by the wavelength-selective beam splitter 30 and returned to the TOF transceiver assembly 10 along the second axis Y, and the second return beam passes through the wavelength-selective beam splitter 30 and is returned to the FMCW transceiver assembly 20 along the first axis X.

In some embodiments, the TOF transceiver assembly 10 is disposed along the first axis X on a side of the wavelength-selective beam splitter 30 away from the optical de-rotation assembly 40, and the FMCW transceiver assembly 20 is disposed along the second axis Y. The first optical beam passes through the wavelength-selective beam splitter 30 along the first axis X and is incident to the de-rotating prism 41 along the first axis X. The second optical beam is incident to the wavelength-selective beam splitter 30 along the second axis Y, reflected by the wavelength-selective beam splitter 30, and incident to the de-rotating prism 41 along the first axis X. Both the first optical beam and the second optical beam are incident to the de-rotating mirror 42 along the first axis X.

Correspondingly, the first return beam and the second return beam are reflected by the de-rotating mirror 42, incident to the de-rotating prism 41 along the first axis X, and incident to the wavelength-selective beam splitter 30 along the first axis X. The first return beam passes through the wavelength-selective beam splitter 30 and is returned to the TOF transceiver assembly 10 along the first axis X, and the second return beam is reflected by the wavelength-selective beam splitter 30 and returned to the FMCW transceiver assembly 20 along the second axis Y.

In the above embodiments, by disposing a wavelength-selective beam splitter in the LiDAR, the first optical beam emitted by the TOF transceiver assembly and the second optical beam emitted by the FMCW transceiver assembly are combined, and the first return beam formed by the first optical beam and the second return beam formed by the second optical beam are split, thereby realizing the integrated use of the TOF transceiver assembly and the FMCW transceiver assembly. By integrating the TOF transceiver assembly and the FMCW transceiver assembly in the same LiDAR and rotating the optical de-rotation assembly, omnidirectional scanning without image rotation is achieved. Without increasing or with minimal increase in the volume of the LiDAR, the reuse of two radar technologies, namely the TOF method and the FMCW method, is realized, so that the LiDAR can simultaneously perform distance and velocity measurements and acquire high-density point cloud data about objects. This enables the LiDAR to eliminate the structure of traditional multi-line LiDAR upper and lower warehouses, reduce the number of components, and has the advantages of no fast-axis scanning, small moment of inertia, simple structure, high reliability, easy assembly, and integrable miniaturization, thus having good development prospects in the field of vehicle-mounted LiDARs.

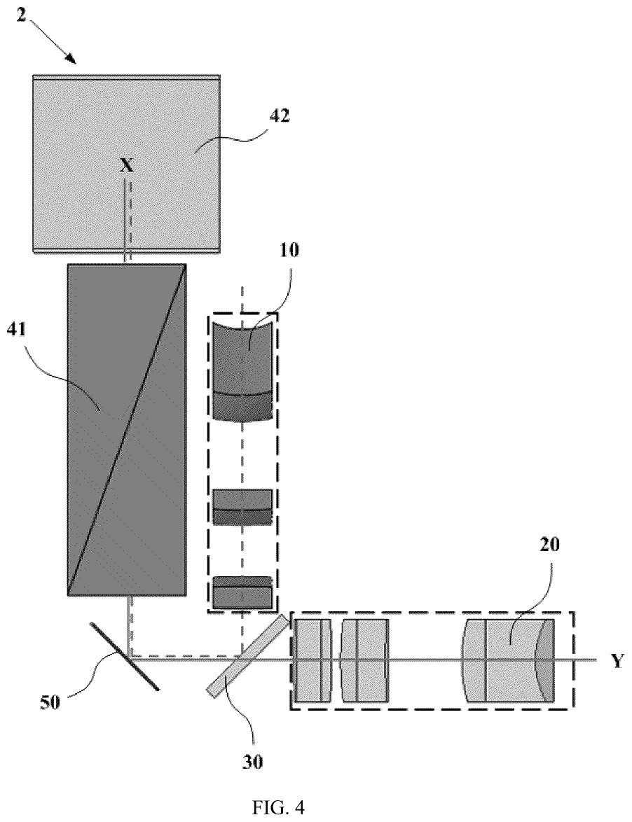

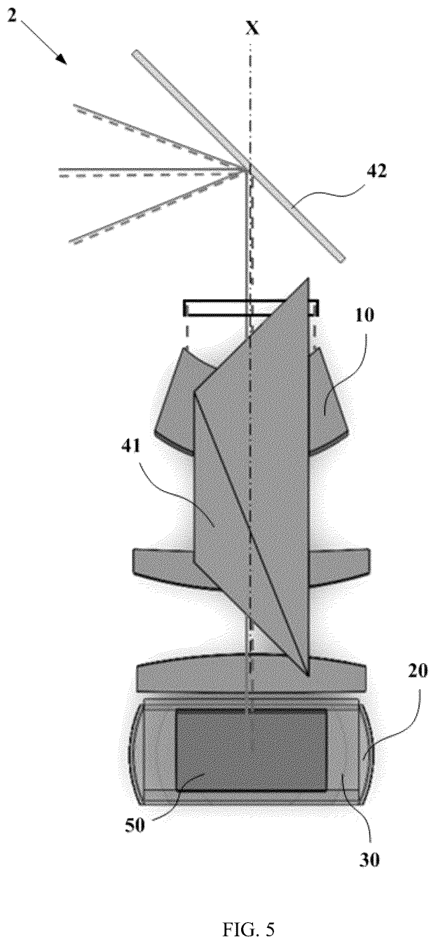

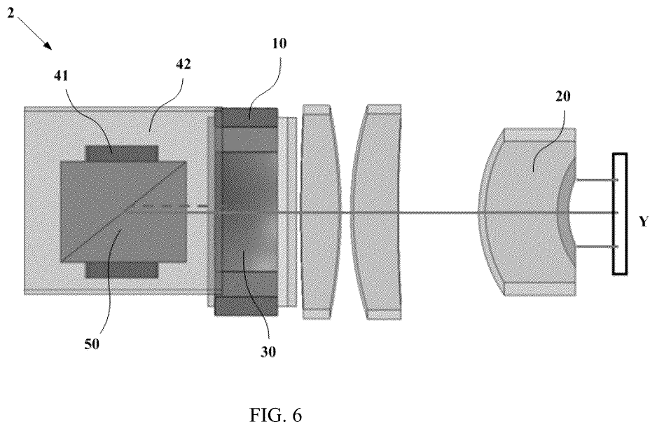

Referring to FIGS. 4-6, FIG. 4 is a first front view of a LiDAR in accordance with an embodiment. FIG. 5 is a left view of a LiDAR in accordance with an embodiment. FIG. 6 is a bottom view of a LiDAR in accordance with an embodiment. The difference between the LiDAR 2 in the second embodiment and the LiDAR 1 in the first embodiment is that the LiDAR 2 in the second embodiment further comprises an optical path reflector 50 disposed on the optical path between the wavelength-selective beam splitter 30 and the optical de-rotation assembly 40.

In this embodiment, the optical path reflector 50 is rotated 45° counterclockwise along the first axis X, and the reflective surface of the optical path reflector 50 is located on a side close to the optical de-rotation assembly 40. The wavelength-selective beam splitter 30 is rotated 45° clockwise along the first axis X, and the reflective surface of the wavelength-selective beam splitter 30 is located on a side close to the optical de-rotation assembly 40.

When the wavelength-selective beam splitter 30 allows the first optical beam to pass through and reflects the second optical beam, the TOF transceiver assembly 10 is disposed along the second axis Y, and the FMCW transceiver assembly 20 is disposed along a direction parallel to the first axis X. The TOF transceiver assembly 10 is located on a side of the wavelength-selective beam splitter 30 away from the optical de-rotation assembly 40, and the FMCW transceiver assembly 20 faces the reflective surface of the wavelength-selective beam splitter 30.

When the wavelength-selective beam splitter 30 reflects the first optical beam and allows the second optical beam to pass through, the TOF transceiver assembly 10 is disposed along a direction parallel to the first axis X, and the FMCW transceiver assembly 20 is disposed along the second axis Y. The FMCW transceiver assembly 20 is located on a side of the wavelength-selective beam splitter 30 away from the optical de-rotation assembly 40, and the TOF transceiver assembly 10 faces the reflective surface of the wavelength-selective beam splitter 30.

Taking the LiDAR 2 shown in FIG. 4 as an example, the wavelength-selective beam splitter 30 reflects the first optical beam and allows the second optical beam to pass through. The FMCW transceiver assembly 20 is disposed along the second axis Y, and the TOF transceiver assembly 10 is disposed along a direction parallel to the first axis X. The optical path reflector 50 is disposed on a side of the wavelength-selective beam splitter 30 away from the FMCW transceiver assembly 20. That is, the optical path reflector 50, the wavelength-selective beam splitter 30, and the FMCW transceiver assembly 21 are sequentially disposed along the second axis Y. In this embodiment, the TOF transceiver assembly 10 and the optical de-rotation assembly 40 are both disposed on a same side of the wavelength-selective beam splitter 30 and are adjacent to each other.

The first optical beam is incident to the wavelength-selective beam splitter 30 along a direction parallel to the first axis X, and the second optical beam passes through the wavelength-selective beam splitter 30 along the second axis Y. After propagating the wavelength-selective beam splitter 30, the first optical beam and the second optical beam are simultaneously incident to the optical path reflector 50 along the second axis Y and are reflected by the optical path reflector 50 to be incident to the optical de-rotation assembly 40 along the first axis X.

It can be understood that the optical path reflector 50 can enable the TOF transceiver assembly 10 to be disposed along the vertical direction of the LiDAR 1 and the FMCW transceiver assembly 20 to be disposed along the horizontal direction of the LiDAR 2, or enable the TOF transceiver assembly 10 to be disposed along the horizontal direction of the LiDAR 2 and the FMCW transceiver assembly 20 to be disposed along the vertical direction of the LiDAR 1, so that the volume of the LiDAR 2 can be reduced.

In the above embodiments, by disposing an optical path reflector in the LiDAR, the arrangement positions of the TOF transceiver assembly and the FMCW transceiver assembly in the LiDAR can be changed, thereby effectively reducing the volume of the LiDAR and making the LiDAR more integrated and miniaturized.

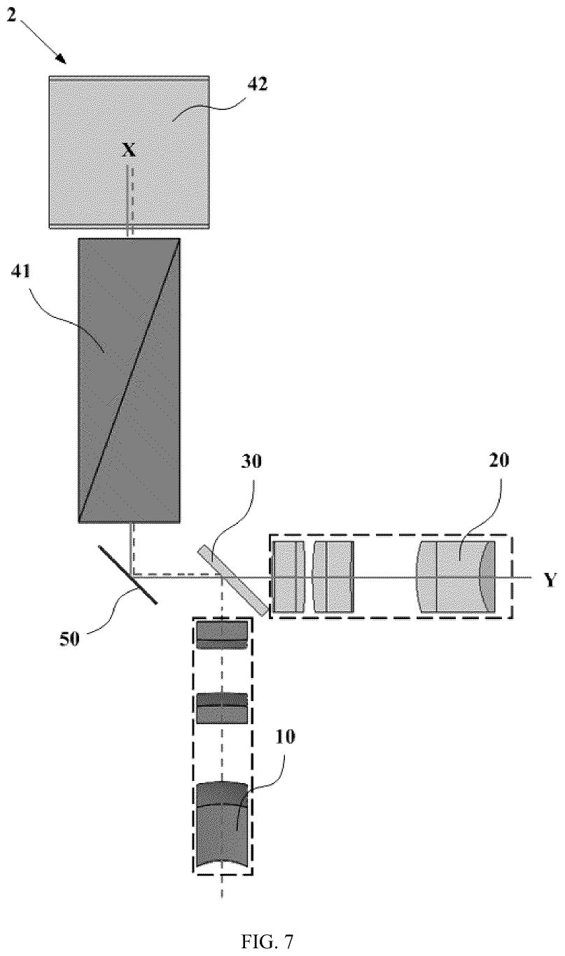

In some embodiments, the wavelength-selective beam splitter 30 can be rotated 45° counterclockwise along the first axis X, and the reflective surface of the wavelength-selective beam splitter 30 is located on a side away from the optical de-rotation assembly 40 (as shown in FIG. 7).

Correspondingly, when the wavelength-selective beam splitter 30 allows the first optical beam to pass through and reflects the second optical beam, the TOF transceiver assembly 10 is disposed along the second axis Y, and the FMCW transceiver assembly 20 is disposed along a direction parallel to the first axis X. The TOF transceiver assembly 10 and the FMCW transceiver assembly 20 are both located on a side of the wavelength-selective beam splitter 30 away from the optical de-rotation assembly 40, and the FMCW transceiver assembly 20 faces the reflective surface of the wavelength-selective beam splitter 30.

When the wavelength-selective beam splitter 30 reflects the first optical beam and allows the second optical beam to pass through, the TOF transceiver assembly 10 is disposed along a direction parallel to the first axis X, and the FMCW transceiver assembly 20 is disposed along the second axis Y. The TOF transceiver assembly 10 and the FMCW transceiver assembly 20 are both located on a side of the wavelength-selective beam splitter 30 away from the optical de-rotation assembly 40, and the TOF transceiver assembly 10 faces the reflective surface of the wavelength-selective beam splitter 30.

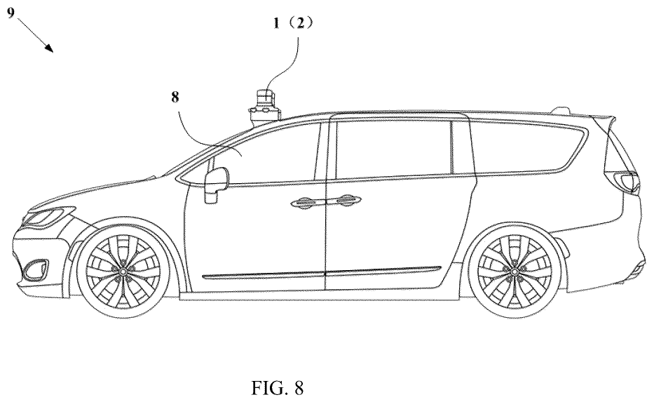

Referring to FIG. 8, which is a schematic diagram of a vehicle provided by an embodiment of the disclosure. The vehicle 9 comprises a vehicle body 8 and the LiDAR 1 or the LiDAR 2. The specific structures of the LiDAR 1 and the LiDAR 2 are referred to the above embodiments. In this embodiment, the LiDAR 1 or the LiDAR 2 is disposed on the vehicle body 8. The position where the LiDAR 1 or the LiDAR 2 is installed on the vehicle body 8 can be set according to actual application requirements, which is not limited here.

Since the vehicle 9 adopts all the technical solutions of the above embodiments, it at least has all the beneficial effects brought by the technical solutions of the above embodiments, which will not be repeated here.

Obviously, those skilled in the art can make various modifications and variations to the disclosure without departing from the spirit and scope of the disclosure. Therefore, if these modifications and variations of the disclosure fall within the scope of the claims of the disclosure and their equivalent technologies, the disclosure also intends to include these modifications and variations.

The above-listed are merely preferred embodiments of the disclosure and cannot be used to limit the scope of the claims of the disclosure. Therefore, equivalent changes made according to the claims of the disclosure still fall within the scope covered by the disclosure.

1. A LiDAR, comprising:
a TOF transceiver assembly;
an FMCW transceiver assembly;
a wavelength-selective beam splitter; and
an optical de-rotation assembly;
wherein:
the wavelength-selective beam splitter is optically coupled to the optical de-rotation assembly;
a first optical beam emitted by the TOF transceiver assembly and a second optical beam emitted by the FMCW transceiver assembly are incident on the optical de-rotation assembly, wherein:
one of the first optical beam or the second optical beam is reflected by the wavelength-selective beam splitter toward the optical de-rotation assembly, and
the other of the first optical beam or the second optical beam passes through the wavelength-selective beam splitter and is incident on the optical de-rotation assembly;
the optical de-rotation assembly is configured to rotate around a first axis, and the first optical beam and the second optical beam are emitted from the LiDAR through the optical de-rotation assembly;
the first optical beam and the second optical beam are reflected by an object to generate a first return beam and a second return beam, respectively;
the first return beam is received by the TOF transceiver assembly after sequentially propagating the optical de-rotation assembly and the wavelength-selective beam splitter; and
the second return beam is received by the FMCW transceiver assembly after sequentially propagating the optical de-rotation assembly and the wavelength-selective beam splitter.

2. The LiDAR according to claim 1, wherein the optical de-rotation assembly comprises:
a de-rotating prism; and
a de-rotating mirror;
wherein:
the de-rotating mirror is disposed on a side of the de-rotating prism opposite to the wavelength-selective beam splitter;
the first return beam and the second return beam, after propagating through the wavelength-selective beam splitter, are:
simultaneously incident on the de-rotating prism along the first axis; and
subsequently emitted from the LiDAR system via reflection by the de-rotating mirror.

3. The LiDAR according to claim 2, wherein a first rotation speed of the de-rotating prism rotating around the first axis is different from a second rotation speed of the de-rotating mirror rotating around the first axis.

4. The LiDAR according to claim 3, wherein the second rotation speed is twice the first rotation speed.

5. The LiDAR according to claim 2, wherein the first optical beam is directed to the de-rotating prism by reflection at the wavelength-selective beam splitter; the second optical beam is transmitted through the wavelength-selective beam splitter to the de-rotating prism; the first return beam is reflected by the wavelength-selective beam splitter toward the TOF optical transceiver module; and the second return beam is transmitted through the wavelength-selective beam splitter to the FMCW optical transceiver assembly.

6. The LiDAR according to claim 5, wherein the FMCW optical transceiver assembly is positioned along the first axis on a side of the wavelength-selective beam splitter opposite to the optical de-rotation assembly; the TOF optical transceiver module is arranged along a second axis perpendicular to the first axis; the first optical beam is incident on the wavelength-selective beam splitter along the second axis; and the second optical beam propagates through the wavelength-selective beam splitter along the first axis.

7. The LiDAR according to claim 5, wherein the FMCW optical transceiver assembly is positioned along a secondary axis perpendicular to the primary axis; the TOF optical transceiver module is arranged along a direction parallel to the primary axis; the first optical beam is incident on the wavelength-selective beam splitter along the direction parallel to the primary axis; and the second optical beam propagates through the wavelength-selective beam splitter along the secondary axis.

8. The LiDAR according to claim 7, wherein the LiDAR further comprises an optical path reflector, wherein the optical path reflector is disposed on a side of the wavelength-selective beam splitter away from the FMCW transceiver assembly; after propagating the wavelength-selective beam splitter, the first optical beam and the second optical beam are simultaneously incident to the optical de-rotation assembly via reflection by the optical path reflector.

9. The LiDAR according to claim 7, wherein the TOF transceiver assembly and the optical de-rotation assembly are both disposed on a same side of the wavelength-selective beam splitter and are adjacent to each other.

10. The LiDAR according to claim 1, wherein the wavelength-selective beam splitter is a dichroic mirror.

11. A vehicle, comprising:
a vehicle body; and
a LiDAR, mounted on the vehicle body, the LiDAR comprising:
a TOF transceiver assembly;
an FMCW transceiver assembly;
a wavelength-selective beam splitter; and
an optical de-rotation assembly;
wherein:
the wavelength-selective beam splitter is optically coupled to the optical de-rotation assembly;
a first optical beam emitted by the TOF transceiver assembly and a second optical beam emitted by the FMCW transceiver assembly are incident on the optical de-rotation assembly, wherein:
one of the first optical beam or the second optical beam is reflected by the wavelength-selective beam splitter toward the optical de-rotation assembly, and
the other of the first optical beam or the second optical beam passes through the wavelength-selective beam splitter and is incident on the optical de-rotation assembly;
the optical de-rotation assembly is configured to rotate around a first axis, and the first optical beam and the second optical beam are emitted from the LiDAR through the optical de-rotation assembly;
the first optical beam and the second optical beam are reflected by an object to generate a first return beam and a second return beam, respectively;
the first return beam is received by the TOF transceiver assembly after sequentially propagating the optical de-rotation assembly and the wavelength-selective beam splitter; and
the second return beam is received by the FMCW transceiver assembly after sequentially propagating the optical de-rotation assembly and the wavelength-selective beam splitter.

12. The LiDAR according to claim 11, wherein the optical de-rotation assembly comprises:
a de-rotating prism; and
a de-rotating mirror;
wherein:
the de-rotating mirror is disposed on a side of the de-rotating prism opposite to the wavelength-selective beam splitter;
the first return beam and the second return beam, after propagating through the wavelength-selective beam splitter, are:
simultaneously incident on the de-rotating prism along the first axis; and
subsequently emitted from the LiDAR system via reflection by the de-rotating mirror.

13. The LiDAR according to claim 12, wherein a first rotation speed of the de-rotating prism rotating around the first axis is different from a second rotation speed of the de-rotating mirror rotating around the first axis.

14. The LiDAR according to claim 13, wherein the second rotation speed is twice the first rotation speed.

15. The LiDAR according to claim 12, wherein the first optical beam is directed to the de-rotating prism by reflection at the wavelength-selective beam splitter; the second optical beam is transmitted through the wavelength-selective beam splitter to the de-rotating prism; the first return beam is reflected by the wavelength-selective beam splitter toward the TOF optical transceiver module; and the second return beam is transmitted through the wavelength-selective beam splitter to the FMCW optical transceiver assembly.

16. The LiDAR according to claim 15, wherein the FMCW optical transceiver assembly is positioned along the first axis on a side of the wavelength-selective beam splitter opposite to the optical de-rotation assembly; the TOF optical transceiver module is arranged along a second axis perpendicular to the first axis; the first optical beam is incident on the wavelength-selective beam splitter along the second axis; and the second optical beam propagates through the wavelength-selective beam splitter along the first axis.

17. The LiDAR according to claim 15, wherein the FMCW optical transceiver assembly is positioned along a secondary axis perpendicular to the primary axis; the TOF optical transceiver module is arranged along a direction parallel to the primary axis; the first optical beam is incident on the wavelength-selective beam splitter along the direction parallel to the primary axis; and the second optical beam propagates through the wavelength-selective beam splitter along the secondary axis.

18. The LiDAR according to claim 17, wherein the LiDAR further comprises an optical path reflector, wherein the optical path reflector is disposed on a side of the wavelength-selective beam splitter away from the FMCW transceiver assembly; after propagating the wavelength-selective beam splitter, the first optical beam and the second optical beam are simultaneously incident to the optical de-rotation assembly via reflection by the optical path reflector.

19. The LiDAR according to claim 17, wherein the TOF transceiver assembly and the optical de-rotation assembly are both disposed on a same side of the wavelength-selective beam splitter and are adjacent to each other.

20. The LiDAR according to claim 11, wherein the wavelength-selective beam splitter is a dichroic mirror.
